(19) United States
(12) Patent Application Publication
(10) Pub. No.: US 2010/0215559 A1
(43) Pub. Date: Aug. 26, 2010

(54) Method for manufacturing extremly pure amorphous boron, in particular for use in MgB2 superconductors

(75) Inventors: Andrè Aubele, Hanau (DE); Bernd Sailer, Alzenau (DE)

Correspondence Address: KOHLER SCHMID MOEBUS, RUPPMANNSTRASSE 27, D-70565 STUTTGART, DE

(73) Assignee: Bruker HTS GmbH, Hanau (DE)

(21) Appl. No.: 12/656,871

(22) Filed: Feb. 18, 2010

(30) Foreign Application Priority Data
Feb. 20, 2009 (DE) 10 2009 009 804.6

(51) Int. Cl. C01B 35/04; C01B 35/02; B01J 8/02

(52) U.S. Cl. 423/289; 423/298; 422/212

(57) ABSTRACT

A method for producing extremely pure amorphous boron, wherein a reducing gas and a gaseous boron halide are introduced continuously or quasi-continuously into a reaction chamber (10; 32) of a reactor (8; 9; 30; 42) during its operation, wherein a surface of a catalyst (15; 20; 37) is provided in the reaction chamber (10; 32) of the reactor (8; 9; 30; 42), which supports the reaction of the boron halide to form boron; and wherein the boron that is deposited on the surface of the catalyst (15; 20; 37) is regularly mechanically removed such that the removed boron is available in the form of powder in the reaction chamber (10; 32) of the reactor (8; 9; 30; 42). The method produces extremely pure amorphous boron which already has a very small grain size without downstream disintegration of the extracted boron. The use of boron powder produced in this fashion is proposed, in particular, for the superconductor production in the magnesium boron system due to the improved current carrying capacity.

This application claims Paris Convention priority of DE 10 2009 009 804.6 filed Feb. 20, 2009 the complete disclosure of which is hereby incorporated by reference.

### BACKGROUND OF THE INVENTION

The invention concerns a method for manufacturing extremely pure amorphous boron, wherein a reducing gas and a gaseous boron halide are continuously or quasi-continuously introduced into a reaction chamber of a reactor during its operation.

A method of this type is disclosed in US 2008 0056976 A1.

Since the discovery of superconductivity in the magnesium boron system, great expense has been invested in the further development of this system. For this reason, great progress has been made with respect to the performance of the superconducting materials compared to other superconducting systems. It has turned out that the quality of the initial materials has a great influence on the performance of an MgB₂ superconductor. The quality of the boron that is used is thereby decisive. According to the prevailing opinion, the production of magnesium diboride (MgB₂) requires amorphous boron of the highest possible purity. The current-carrying capacity, which is an essential feature for the performance of a superconductor, can be influenced, in particular, by the grain size of the boron powder that is used. Fine-grained powders having a tight grain size distribution are thereby desired, since they yield a greater current carrying capacity in the MgB₂ material than coarse-grained powders.

There are various conventional methods for manufacturing boron. Boron is gained e.g. in an aluminothermal fashion. Aluminothermy is a method that is often used in technology, in which metallic elements (in the present case boron) are obtained from the corresponding metal oxides through reaction with elemental aluminium or other base metallic reducing agents (e.g. Mg or alkali metals). The boron obtained in this fashion has only a relatively low purity (up to approximately 95%) such that expensive cleaning methods, e.g. successive washing stages, are subsequently required in order to obtain higher purity values. The cleaning methods considerably increase the costs for the inherently relatively inexpensive aluminothermal production method. The low purity of the boron obtained through aluminothermy substantially results from oxygen impurities caused by the presence of the metal oxides during the aluminothermal reaction. These oxygen impurities can have a disadvantageous insulating effect in the later magnesium diboride superconductor if they are not eliminated.

In another conventional boron extraction method for producing boron fibers, the boron halides are reduced to boron fibers by injecting them into a plasma. Boron fibers of this type are preferably used for fiber composite materials due to their high loading capacity. Compared to the aluminothermal production method, this method produces boron having higher purity values, but is also relatively expensive. Moreover, this method partially also has to deal with oxygen impurities.

Another method discloses reaction of boron halides on metal surfaces in the presence of hydrogen for obtaining different boron modifications, wherein a boron modification and the respective hydrogen halide are produced (http://www.seilnacht.com/Lexikon/05Bor.htm). This method also produces boron having a higher purity compared to aluminothermal production methods. However, this method does not provide a continuous reaction control that would allow extraction of larger amounts of boron. Controlled influence on the resulting particle size of the boron is furthermore difficult.

In the above-mentioned document US 2008 0056976 A1, doped boron is applied as a coating onto a fiber-like substrate of silicium carbide for producing a superconducting MgB₂ wire through reaction of gaseous BCl₃ with H₂. The fiber that is coated with boron in this fashion is subsequently exposed to magnesium vapor to obtain doped magnesium diboride (MgB₂) as a superconductor. However, this method can only be used to produce wires having a silicium carbide core. In particular, boron powder cannot be obtained.

It is the underlying purpose of the present invention to provide an economical method for producing relatively large amounts of extremely pure amorphous boron, which provides good control of the resulting particle size of the boron and which is particularly suited for extracting fine-grained boron powder for producing MgB₂ superconducting material.

### SUMMARY OF THE INVENTION

This object is achieved by a method of the above-mentioned type, which is characterized in that
a) a surface of a catalyst is provided in the reaction chamber of the reactor, which supports the reaction of the boron halide to boron; and
b) the boron that has deposited on the surface of the catalyst is regularly mechanically removed such that the removed boron is available in the form of powder in the reaction chamber of the reactor.

The inventive method is used to produce extremely pure amorphous boron which already has very small grain sizes without additional further processing. The boron powder produced in this fashion can, in particular, be used for producing MgB₂ superconducting material having a high current carrying capacity.

For the inventive boron powder extraction, the gaseous boron halide and the reducing gas (normally hydrogen) are introduced into the reaction chamber. In the presence of the catalyst, which may e.g. consist of tungsten or tantalum, the introduced gases react to form boron and a volatile further reaction product (typically the respective hydrogen halide). The boron is thereby initially deposited on the surface of the catalyst. When a certain amount of boron has been deposited on the catalyst, the boron is removed from the catalyst. In accordance with the invention, the boron is removed from the catalyst surface through regular mechanical processes such that a fine-grained extremely pure boron powder is obtained. Mechanical processes in accordance with the invention may e.g. be vibrating, scratching, scraping, or also fluid-mechanical processes such as e.g. the use of pressure waves of a gas. The regular (repetitive) processes are preferably performed periodically such that any removal yields boron particles of similar sizes.

One essential advantage of the invention is therefore that the inventive method permits extraction of boron in a continuous or quasi-continuous process and is therefore also suited for relatively large boron amounts.

Gaseous hydrogen is typically used as the reducing gas and boron trichloride (BCl₃) is generally used as the gaseous boron halide. Introduction of these and other substances (starting materials) into the reaction chamber is performed in a continuous or quasi-continuous fashion. Quasi-continuous processes are e.g. processes that continue in a similar or uniform fashion but may be characterized by charges (e.g. pulses) or also temporary interruptions. The deposition of boron on the catalyst proceeds during continuous or quasi-continuous introduction of the starting materials.

One substantial advantage of the invention consists in that the boron powder may be produced with a very small particle size and at the same time extremely high purity. This improves the overall current carrying capacity of a superconductor of magnesium diboride. The particle size of the deposited boron can be influenced by the frequency with which the boron is mechanically removed from the catalyst surface and also by the speed with which the boron is deposited on the catalyst surface. This speed can e.g. be adjusted through selection of the catalyst material (tantalum, tungsten, etc.) or other influencing variables such as the reaction temperature.

One further advantage of the invention is the use of purely gaseous starting materials for the reaction to form boron powder. These are commercially available in extremely pure states.

Another advantage consists in that, in the inventive method, only one gaseous side product, normally a hydrogen halide, is produced in addition to boron powder. This obviates expensive cleaning methods such as e.g. the washing processes which follow the conventional aluminothermal boron extraction methods. In accordance with the inventive method, gaseous hydrogen halide is generated and the boron is “precipitated” as solid matter, which simplifies separation of the reaction products from each other. The boron powder can e.g. be collected by a sump-like reservoir in the lower region of the reaction chamber by utilizing gravity, whereas the gaseous reaction product is discharged via a corresponding outlet on the reaction chamber.

The inventive method advantageously produces the finest boron powder which, at the same time, also has extremely high purity. This is due, in particular, to the fact that oxygen does not participate in the reaction of e.g. hydrogen and boron trichloride to form boron and hydrogen chloride. The controlled absence of oxygen during the reaction prevents undesired oxygen impurities.

Finally, the improved current carrying capacity of a superconductor that is produced from boron powder manufactured according to the invention, which is due to the high purity and small grain size of the boron powder, is a substantial advantage for the performance of the superconductor.

In one preferred variant of the inventive method, the deposited boron is mechanically removed during operation of the reactor. Operation of the reactor is characterized in accordance with the invention by the continuous provision of the starting materials of the reaction in the reaction chamber over a relatively long time period (e.g. 5 minutes or longer). In accordance with this method variant, more boron may be accumulated on the catalyst directly after removal or discharge of boron powder from the catalyst, wherein the further accumulation of boron is stripped again in a subsequent removal cycle. In this case, it is not necessary to put the reactor into operation for the generally only small boron powder amount of one single boron accumulation on the catalyst, and subsequently switch it off again, but it is advantageously possible to produce relatively large amounts of boron powder by removing boron several times during operation of the reactor.

In another preferred variant of the inventive method, the catalyst is oscillated for mechanically removing the deposited boron from the surface of the catalyst. When the oscillation of the catalyst is e.g. periodically forced in the reaction chamber, the accompanying alternating acceleration and deceleration of the catalyst surface results in regular and easily effected release of the formed boron powder. The adhesive forces that make the boron adhere to the catalyst are overcome. An oscillating catalyst of this type can e.g. be designed as a solid tantalum or tungsten piece that is disposed in the reaction chamber in such a fashion that it can oscillate and is driven from outside of the reaction chamber to perform periodic oscillating motions.

Another particularly preferred variant of the inventive method is characterized in that, for mechanical removal of the deposited boron from the surface of the catalyst, a pressure gas wave is guided over the surface of the catalyst. This forgoes any expensive motorization for mechanically removing the boron powder from the catalyst. The adhesive force holding the boron on the catalyst is instead overcome by the fluid-mechanical process of the pulsating pressure gas wave. This method variant has moreover the advantageous side effect that the gas in the reaction chamber is strongly whirled. The boron halides that participate in the chemical reaction and the reducing gas are thereby ultra-finely distributed in the reaction chamber. This supports effective and homogeneous reaction to form finely sized boron.

In another preferred method variant, the surface of the catalyst is stripped off for mechanically releasing the deposited boron from the surface of the catalyst. Stripping of the catalyst to remove the boron can be realized in a simple fashion through constructive mechanical solutions. Disks of catalytic material, which partially abut each other, may e.g. rub against each other by rotating them, and thereby remove the boron powder that is accumulated on the respective free catalyst surface. Another feasible solution are stripping devices that are guided along closed pipe circuits of catalytic material, thereby brushing off the accumulating boron from the pipe surface like a broom.

In another method variant, hydrogen gas is used as the reducing gas. Hydrogen gas is a chemical element that is used for numerous chemical applications in industry and technology and is therefore generally readily available. In an alternative fashion, saturated hydrocarbons, such as methane or also ammonia, may e.g. also be used. It is thereby possible, if necessary, to introduce defined dopings, e.g. with C or N into the boron.

In a further preferred method variant, BCl₃ or BBr₃ are used as boron halide. Boron trichloride (BCl₃) is advantageously commercially available in an extremely pure form. The less frequent boron tribromide (BBr₃) is also well suitable for obtaining amorphous boron powder.

In a particularly preferred method variant, the reaction between the reducing gas and the boron halide is controlled at a temperature of between 700° C. and 1100° C., and preferably between 800° C. and 1000° C. The reaction to form amorphous boron is particularly efficient in this temperature range. Crystalline boron portions are minimized. Crystalline boron is difficult to convert into magnesium diboride and generally leads to inclusions in the superconducting material which reduce performance. The reaction temperature can be set via heating elements which are mounted e.g. to the reaction chamber wall.

The invention also concerns use of a reactor in the above-described inventive method, wherein the catalyst is disposed on at least one inner wall of the reaction chamber of the reactor, and wherein, for mechanically releasing the deposited boron from the surface of the catalyst, a mechanical actuator is provided which can be used to oscillate the reaction chamber of the reactor. The overall reaction chamber can be oscillated according to this use, wherein the mechanical actuator does not have to project into the interior space of the reaction chamber (which would typically require expensive sealing measures). The construction of the reaction chamber is then particularly simple. The inner wall (or the inner walls), on which the catalyst is disposed, is/are typically heated, in particular, electrically heated, whereby the temperature in the reaction chamber, in particular on the catalyst, can be influenced in a direct and simple fashion.

The present invention also concerns use of a reactor in accordance with one of the above-mentioned variants of the inventive method, wherein the catalyst is disposed inside the reaction chamber of the reactor, and wherein, for mechanical removal of the deposited boron from the surface of the catalyst, a mechanical actuator is provided, by means of which the catalyst in the interior of the reaction chamber of the reactor can be oscillated. It is thereby advantageously not necessary to oscillate the overall reaction chamber, but instead limit the oscillating movement to the catalysts that are substantially involved in the boron powder production. This is advantageous, in particular, for relatively large reaction chambers. By arranging the catalyst in the interior of the reaction chamber, the reaction may moreover take place in an area of the reaction chamber that is generally thoroughly mixed. The result is an effective and homogeneous reaction that leads to high purity of the boron powder. The catalyst is typically heated, in particular, electrically heated. The reaction temperature can therefore be easily adjusted.

The invention also concerns the use of a reactor according to one of the above-mentioned variants of the inventive method, wherein the reactor has a pulsation chamber and the reaction chamber, wherein the pulsation chamber and the reaction chamber are connected to each other via a common opening, the flow cross-section of the pulsation chamber being larger than the flow cross-section of the reaction chamber, wherein the pulsation chamber is filled with a burning gas and an oxidation gas via a flap system, with the burning gas and the oxidation gas forming an explosive gas mixture in the pulsation chamber, which is regularly exploded, wherein the flap system automatically closes in case the pressure in the pulsation chamber increases due to the explosion.

If the pulsation chamber has no other outlet openings except for the common opening with the reaction chamber, gas flows through the pulsation chamber and the reaction chamber in spatial and temporal succession. This gas flow generally consists of the starting materials and products of the explosive gas mixture, and the starting materials and the products of boron powder formation, wherein the starting materials for the boron powder production may first be supplied in the reaction chamber. The gas flow is “driven” quasi continuously by the pulsating combustion of the explosive gas mixture in the pulsation chamber or is advanced in pulses and is thereby pushed through the reaction chamber. Boron powder is formed on the catalyst in the reaction chamber. The pulsating advance of the gas flow is thereby not only utilized for providing the boron powder reaction starting materials in the reaction chamber but at the same time for regular fluid-mechanical removal of the generated boron from the catalyst. In dependence on the utilized explosive gas mixture, different ignition mechanisms may be used. In case of a hydrogen oxygen mixture, ignition may be effected e.g. by an electrically generated spark. In the most favorable case, this even generates a self-perpetuating pulsating combustion. In case of a hydrogen-chlorine gas mixture, the ignition may also be effected by UV light.

This use is particularly advantageous due to the thorough mixing of the starting materials in the reaction chamber, which results in an effective and homogeneous reaction to form finely sized amorphous boron. The different flow cross-sections of the two chambers increase the pressure gas wave effect in the reaction chamber such that even small amounts of the explosive gas mixture advantageously also mechanically remove or strip off the boron powder from the catalyst. The flap system, which may e.g. be formed from simple check valves for the burning gas and oxidation gas, ensures the quasi-continuous flow of the burning gas and oxidation gas into the pulsation chamber, and also ensures closure of the check valves shortly after ignition of the explosive gas mixture, thereby ensuring temporary interruption of the supply of the starting materials of the explosive gas mixture. The overall flap system thereby ensures controlled pulsating quasi-continuous combustion.

One variant of the above-mentioned use is characterized in that the pulsation chamber has an outlet, in particular, a resonance tube, for relieving the explosion pressure. This prevents parts of the oxidation gas, which may have not completely reacted during explosion of the explosive gas mixture, from being displaced into the reaction chamber where it might cause e.g. undesired oxygen impurities. The outlet or resonance tube is directly connected to the pulsation chamber. For this reason, the major part of the pressure wave is discharged via the resonance tube. A smaller part of the pressure wave is transferred to the reaction chamber where the boron powder is further mechanically removed from the catalyst by the pressure wave. The reduced pressure wave effect prevents oxidation gas from being displaced into the reaction chamber.

The pulsation chamber with connected outlet and the reaction chamber may also comprise a common, at least largely gas-impermeable elastic diaphragm (e.g. a close-meshed metal wire braiding made from an inert material) or a common piston that can move into both chambers, instead of a common connecting opening. This diaphragm or movable piston is connected to the interior of the pulsation chamber and also to the interior of the reaction chamber. In other words: a diaphragm or piston of this type represents a kind of link between the pulsation chamber and the reaction chamber, wherein the respective interiors remain separated from each other. During use of a reactor of this type, the oxidation gas and the burning gas are directly introduced into the pulsation chamber and the reducing gas and the boron halide are directly introduced into the reaction chamber. Each repeated ignition of the explosive gas mixture in the pulsation chamber causes temporary impulsive bulging of the diaphragm or deflection of the piston into the reaction chamber, thereby initiating repeated pressure gas waves through the reaction chamber, which regularly mechanically remove the boron collected on the catalyst. The provision of an outlet (e.g. resonance tube) of the pulsation chamber ensures that the elastic diaphragm is not destroyed by an excessive pressure increase in the pulsation chamber. This reactor design ensures that no oxidation gas, in particular no oxygen, can enter into the reaction chamber. This guarantees clean extraction of boron.

In a variant of the two above-mentioned types of use, the burning gas that is used in the explosive gas mixture in the pulsation chamber is the same gas as the reducing gas that is used in the reaction chamber. This advantageously reduces the complexity of the method, since, in this case, only a few different substances are involved in the production of the amorphous boron.

In another variant of the above-mentioned types of use, an excessive amount of burning gas is used in the explosive gas mixture compared to the oxidation gas. Typical burning gas is thereby hydrogen and typical oxidation gas is oxygen or air or an air mixture. The advantage of an excessive amount of burning gas consists in that this excessive amount causes complete consumption of the oxidation gas, thereby preventing oxidation gas from entering into the reaction chamber. When the gas that is used in the pulsation chamber as the burning gas of the explosive gas mixture is the same gas as the reducing gas in the reaction chamber, separate introduction of the reducing gas into the reaction chamber is not necessary, since the burning gas, an excessive amount of which has been introduced into the pulsation chamber and has not reacted after the effected explosion, can be used as reducing gas for the boron powder production when it has entered the reaction chamber via the common opening. Hydrogen or chloride can also be used as a further combination of burning gas and oxidation gas.

A further variant of the above-mentioned types of use is characterized in that the boron halide is directly, in particular continuously, introduced into the reaction chamber. This permits effective operation of the reactor. In this variant of use, the boron halide does not reach the reaction chamber via the pulsation chamber and the common opening, whereby unused expensive boron halide could escape e.g. via the resonance tube. The boron halide is rather used at that location where the desired boron powder reaction takes place, i.e. directly in the reaction chamber.

In another variant of the above-mentioned types of use, the reducing gas is directly, in particular continuously, introduced into the reaction chamber. This permits more accurate control of the reducing gas. The reducing gas is thereby not only introduced into the reaction chamber via the pulsation chamber and the common opening, but also either additionally or exclusively directly into the reaction chamber, i.e. to that location where the boron powder reaction takes place.

In a further variant of use, the interior of the reaction chamber of the reactor has a meandering shape. This initially increases the inner surface of the reaction chamber. The increased inner surface of the reaction chamber provides an enlarged catalyst surface in the reaction chamber, in particular, on the inner walls of the reaction chamber. A larger catalyst surface can, in turn, be used for increased (more efficient) boron powder extraction. The catalyst may also have a structure that increases its surface.

In another variant of the above-mentioned types of use, the reaction chamber has an outlet that is guided via a particle filter. This facilitates separation of the solid boron powder from the residual gaseous reaction products. The particle filter may thereby also have several stages. The boron powder discharged via the continuous or quasi-continuous gas flow accumulates in the particle filter and can be occasionally removed. The boron powder can be removed from the particle filter e.g. by manually jarring the particle filter. As an alternative or in addition to the particle filter, formation of a sump (reservoir) in the lower area of the reaction chamber is also possible. The boron powder collection in such a sump is a simple constructive solution for separating the boron powder from the gas flow. It is based on the fact that the boron powder that is removed by the pressure gas wave or vibration falls into the sump due to gravity. The gas flow is thereby suitably guided in a horizontal direction such that the detached boron powder grains can precipitate in a vertical direction and are thereby separated from the gas flow. The boron powder accumulated in the sump can then e.g. be manually removed.

A superconducting structure containing MgB₂ is also preferred, wherein the MgB₂ is produced by a reaction between magnesium and boron, the boron being produced in accordance with the inventive method. A superconducting structure of this type has high purity and a fine structure to obtain a high current carrying capacity.

Further advantages of the invention can be extracted from the description and the drawing. The features mentioned above and below may be used in accordance with the invention either individually or collectively in arbitrary combination. The embodiments shown and described are not to be taken as exhaustive enumeration but have exemplary character for describing the invention.

The invention is shown in the drawing and is explained in more detail with reference to embodiments.

### BRIEF DESCRIPTION OF THE DRAWINGS

FIG. 1 shows a schematic view of a reactor with catalysts that are disposed on inner walls of a reaction chamber for performing the inventive method;

FIG. 2 shows a schematic view of a reactor with catalysts that are disposed in the inside of a reaction chamber for performing the inventive method;

FIG. 3 shows a schematic view of a reactor with a pulsation chamber and a reaction chamber for performing the inventive method; and

FIG. 4 shows a schematic view of a reactor similar to the reactor of FIG. 3, with an additional resonance tube on one pulsation chamber.

### DESCRIPTION OF THE PREFERRED EMBODIMENT

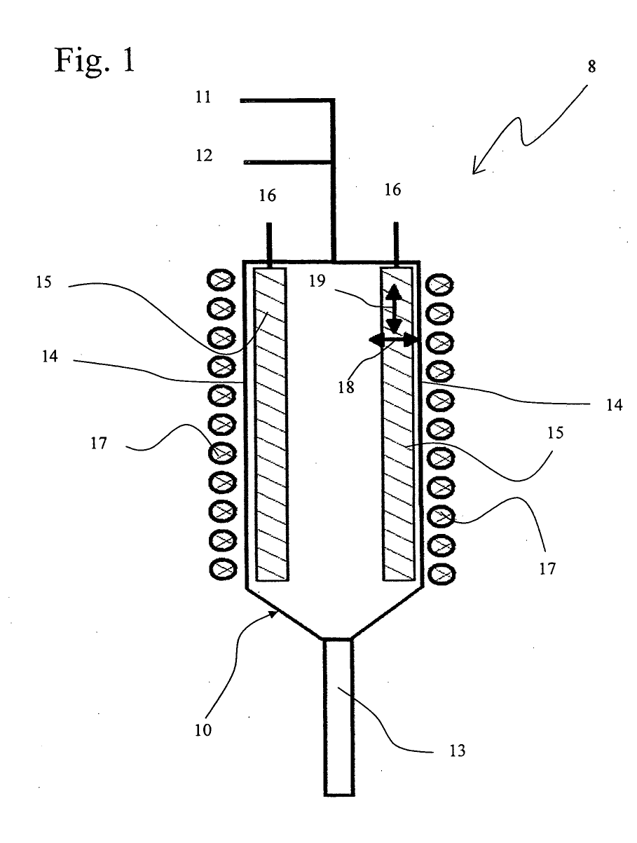

FIG. 1 shows a schematic cross-section through a reactor 8 with a reaction chamber 10, wherein the reactor 8 has a first supply line 11 for a reducing gas and a second supply line 12 for gaseous boron halide, and an outlet 13. The first supply line 11 and the second supply line 12 are thereby combined upstream of the reaction chamber 10 and subsequently open into the reaction chamber 10. It is, however, also possible to guide the supply lines 11, 12 separately into the reaction chamber 10. Catalysts 15 are arranged on an inner wall 14 of the reaction chamber 10, which can be moved via actuators 16. The actuators 16 can be accessed from outside of the reaction chamber 10. Heating elements 17 are disposed on the inner wall 14 for heating the inner wall 14.

The reducing gas, e.g. hydrogen gas, is injected via the first supply line 11 and the gaseous boron halide, e.g. boron trichloride, is injected via the second supply line 12 into the reaction chamber 10 for extracting boron. A chemical reaction takes place, in which solid boron is collected on the surfaces of the catalysts 15, which may consist e.g. of tantalum or tungsten, and the corresponding gaseous reaction product (e.g. hydrogen halide) is additionally generated. The collected boron is removed from the catalysts 15 or their catalyst surfaces e.g. by shaking the actuators 16. The detached boron as well as the generated hydrogen halide can escape via the outlet 13 and subsequently be separated from each other.

The catalysts 15 may be formed from simple rod-shaped or plate-shaped elements or be provided with surface-enlarging structures. The actuators 16 can subject the catalysts 15 to a uniform, vibrating e.g. oscillating motion. The motion comprises, in particular, components in a first, generally horizontal direction 18 and a second direction 19 which is typically perpendicular thereto. A desired temperature can be adjusted in the reaction chamber 10 via the heating elements 17, wherein the heating elements 17 may also represent e.g. lines for liquid or gaseous heating media, or also electric heating conductors.

A typical inventive vibrating program comprises respective alternating inactive phases (without actuator activity) and vibrating phases (with actuator activity), wherein the inactive phases are considerably longer than the vibrating phases.

During the inactive phase, the boron particles accumulate on the catalyst surface, whereas they are removed in the vibrating phase such that subsequently new particles can start to accumulate. The supply of starting material continues non-intermittently during the alternating inactive and vibrating phases.

As an alternative to indirect vibration of the catalysts 15, it is also possible to vibrate the overall reactor chamber 10 including the catalysts 15 (not shown) which are then typically rigidly mounted to the inner wall 14.

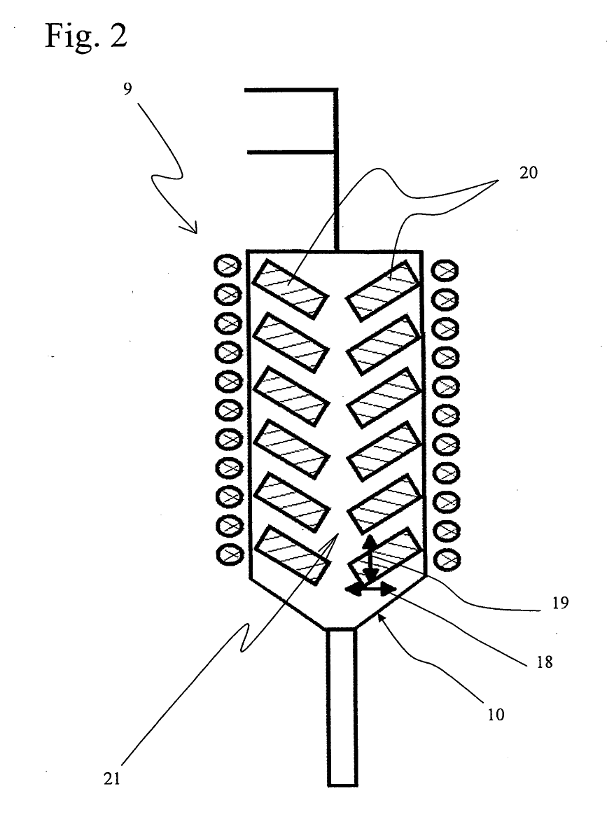

FIG. 2 shows a reactor 9 that is designed like the reactor of FIG. 1, but differs therefrom in that catalysts 20 are disposed in an interior 21 of the reaction chamber 10. These catalysts 20 can be mechanically moved via actuators that are not shown in FIG. 2 (analogously in the first direction 18 and second direction 19) and can themselves be heated, e.g. electrically.

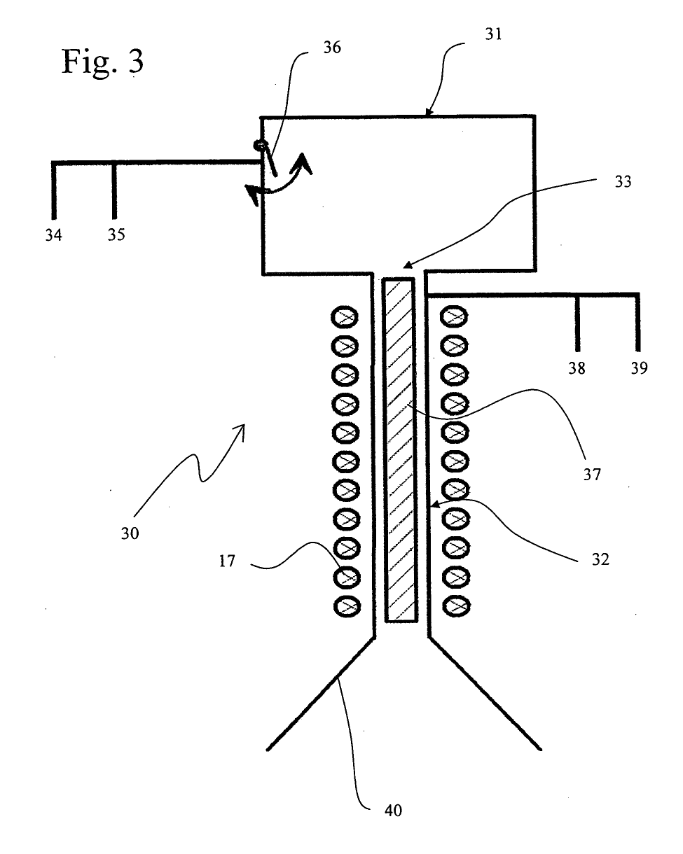

FIG. 3 shows a schematic cross-section through a reactor 30 with a pulsation chamber 31 and a reaction chamber 32. The interiors of the pulsation chamber 31 and the reaction chamber 32 are connected to each other via a common opening 33. The reactor 30 comprises a first inlet 34 for a burning gas and a second inlet 35 for an oxidation gas. Both inlets 34, 35 are combined outside of the pulsation chamber 31 and then open together into the pulsation chamber 31. The inlets 34, 35, may, however, alternatively also be individually guided into the pulsation chamber 31. A flap 36 is provided at the mouth of the combined inlets into the pulsation chamber 31, which can temporarily interrupt introduction of the burning and oxidation gases (when the inlets are individually guided, each mouth has such a flap). The cross-section of the reaction chamber 32 is smaller than that of the pulsation chamber 31 and a catalyst 37 is fixed to the interior of the reaction chamber 32. Heating elements 17 are disposed on the wall of the reaction chamber 32 for controlling the temperature in the reaction chamber 32. The reaction chamber 32 moreover has a third inlet 38 in the area of the common opening 33 for the reducing gas and a fourth inlet 39 for the boron halide. Both inlets 38, 39 are combined outside of the reaction chamber 32 and then commonly open into the reaction chamber 32. The inlets 38, 39 may alternatively also be guided into the reaction chamber 32 separately from each other. An outlet 40 for discharge of the involved substances is formed at the lower end of the reaction chamber 32 shown in FIG. 3.

In FIG. 3, a gas flow flows through both chambers 31, 32 one after the other with respect to space and time, which are heated to the desired reaction temperature, for extracting boron powder. Hydrogen gas and oxygen are e.g. introduced via the first and second inlet 34, 35. The explosive mixture of hydrogen gas and oxygen is ignited e.g. by an electrically generated spark or via UV light e.g. in case of hydrogen and chlorine gas. A pressure wave is generated, which temporarily closes the flap 36, thereby preventing further supply of explosive mixture. The pressure wave is discharged via the common opening 33, the reaction chamber 32 and the outlet 40. The suction following the pressure wave opens the flaps 36 such that the burning and oxidation gases can flow in again and be ignited. A state of quasi-continuous pulsating combustion is generated. The boron halide and the reducing gas are injected via the third and fourth inlet 38, 39 such that the desired reduction to boron takes place on the catalyst 37. The regular mechanical detachment of the solid boron from the catalyst 37 is caused by the pressure wave that continues in a pulsating fashion through the reaction chamber 32. This fluid-mechanical process removes the solid boron from the catalyst surface.

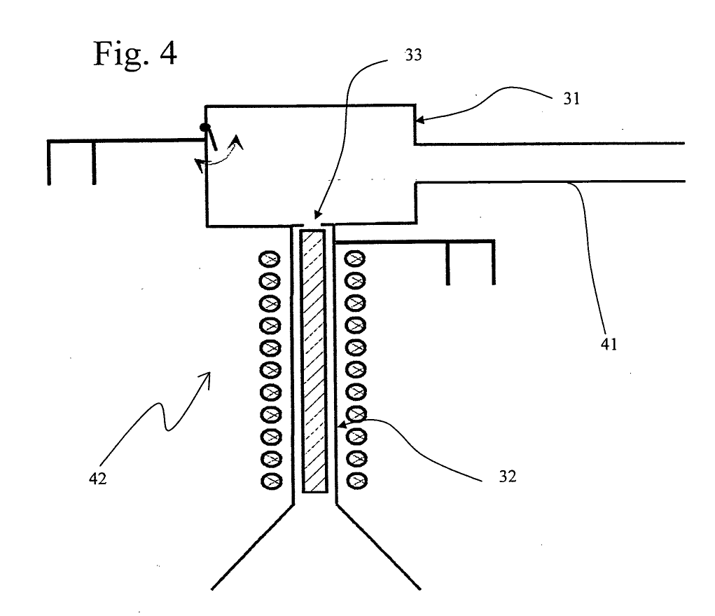

FIG. 4 shows a schematic cross-section through a reactor 42 that is designed like the reactor of FIG. 3 but in contrast thereto, has a resonance tube 41 that is additionally connected to the pulsation chamber 31. The pulsation chamber 31 can be pressure-relieved via the resonance tube 41, such that the pressure wave progressing through the reaction chamber 32 is weakened. The common opening 33 moreover has a cross-sectional narrowing that can also weaken the pressure wave in the reaction chamber 32. The cross-sectional narrowing moreover minimizes displacement of oxidation gas into the reaction chamber 32.

In summary, the invention concerns a method for producing extremely pure amorphous boron, wherein a reducing gas and a gaseous boron halide are continuously or quasi-continuously introduced into a reaction chamber 10, 32 of a reactor 8, 9, 30, 42 during its operation, wherein a surface of a catalyst 15, 20, 37 is provided in the reaction chamber 10, 32 of the reactor 8, 9, 30, 42, which supports reaction of the boron halide to form boron, and wherein the boron deposited on the surface of the catalyst 15, 20, 37 is regularly mechanically detached such that the detached boron is present in the form of powder in the reaction chamber 10, 32 of the reactor 8, 9, 30, 42. The inventive method produces extremely pure amorphous boron which already has a very small grain size without subsequent disintegration of the extracted boron. The use of boron powder produced in this fashion is proposed, in particular, for the production of superconductors in the magnesium boron system due to its improved current carrying capacity.

We claim:

1. A method for producing extremely pure amorphous boron, the method comprising the steps of:
a) continuously or quasi-continuously introducing a reducing gas and a gaseous boron halide into a reaction chamber of a reactor during operation thereof;
b) introducing a catalyst into the reaction chamber, the catalyst supporting a reaction of the boron halide to form boron, wherein boron deposits on a surface of the catalyst;
c) mechanically removing, at regular intervals, boron deposited on the surface of the catalyst, the removed boron thereby being available in the form of powder in the reaction chamber of the reactor.

2. The method of claim 1, wherein the deposited boron is mechanically removed during operation of the reactor.

3. The method of claim 1, wherein the catalyst is vibrated for mechanically removing the deposited boron from the surface of the catalyst.

4. The method of claim 1, wherein a pressure gas wave is guided over the surface of the catalyst for mechanically removing the deposited boron from the surface of the catalyst.

5. The method of claim 1, wherein the surface of the catalyst is stripped for mechanically removing the deposited boron from the surface of the catalyst.

6. The method of claim 1, wherein hydrogen gas is used as the reducing gas.

7. The method of claim 1, wherein BCl₃ or BBr₃ are used as the boron halide.

8. The method of claim 1, wherein the catalyst contains tungsten and/or tantalum.

9. The method of claim 1, wherein the reaction between the reducing gas and the boron halide is controlled at a temperature between 700° C. and 1100° C. or between 800° C. and 1000° C.

10. A use of a reactor in the method for producing extremely pure amorphous boron of claim 1, wherein the catalyst is disposed on at least one inner wall of the reaction chamber of the rector, with a mechanical actuator being provided to vibrate the reaction chamber of the reactor for mechanically removing the deposited boron from the surface of the catalyst.

11. A use of a reactor in the method for producing extremely pure amorphous boron of claim 1, wherein the catalyst is disposed in an interior of the reaction chamber of the reactor, with a mechanical actuator being provided to vibrate the catalyst in the interior of the reaction chamber of the reactor for mechanically removing the deposited boron from the surface of the catalyst.

12. A use of a reactor in the method for producing extremely pure amorphous boron of claim 1, wherein the reactor has a pulsation chamber, the pulsation chamber and the reaction chamber being connected to each other via a common opening, wherein a flow cross-section of the pulsation chamber is larger than a flow cross-section of the reaction chamber and the pulsation chamber is filled with burning gas and oxidation gas via a flap system, the burning gas and the oxidation gas forming an explosive gas mixture in the pulsation chamber which is regularly exploded, wherein the flap system automatically closes when pressure increases in the pulsation chamber due to explosion.

13. The use of claim 12, wherein the pulsation chamber has an outlet or a resonance tube for relieving explosion pressure.

14. The use of claim 12, wherein the burning gas used in the explosive gas mixture in the pulsation chamber is a same gas as the reducing gas used in the reaction chamber.

15. The use of claim 12, wherein an excessive amount of burning gas is used in the explosive gas mixture in comparison with the oxidation gas.

16. The use of claim 12, wherein the boron halide is directly or continuously introduced into the reaction chamber.

17. The use of claim 12, wherein the reducing gas is introduced directly or continuously into the reaction chamber.

18. The use of claim 10, wherein an interior of the reaction chamber of the reactor has a meandering shape.

19. The use of claim 10, wherein the reaction chamber has an outlet that is accessed via a particle filter.

20. A superconducting structure containing MgB₂, wherein the MgB₂ is produced by reaction between magnesium and boron, the boron being produced by the method of claim 1.
